(19) United States
(12) Patent Application Publication
(10) Pub. No.: US 2022/0374510 A1
(43) Pub. Date: Nov. 24, 2022

(54) INFORMATION PROCESSING APPARATUS, INFORMATION PROCESSING METHOD, AND NON-TRANSITORYCOMPUTER READABLE MEDIUM STORING PROGRAM

(71) Applicant: NEC Corporation, Minato-ku, Tokyo (JP)

(72) Inventor: Takayuki Sasaki, Tokyo (JP)

(73) Assignee: NEC Corporation, Minato-ku, Tokyo (JP)

(21) Appl. No.: 17/761,256

(22) PCT Filed: Sep. 27, 2019
(86) PCT No.: PCT/JP2019/038141

§ 371 Date: Mar. 17, 2022

(51) Int. Cl. G06F 21/52; G06F 21/64

(52) U.S. Cl. CPC G06F 21/52; G06F 21/64; G06F 2221/033

(57) ABSTRACT

According to an example embodiment, an information processing apparatus includes: a memory that stores a program; whitelist storage means for storing a whitelist in which first verification data corresponding to each part of the program is listed; arithmetic processing means for executing the program; verification means for verifying whether there is a tampering with each part of the program by comparing the first verification data listed in the whitelist with second verification data that is newly calculated when each part of the program is executed; and information acquisition means for acquiring, when it is determined by the verification means that some part of the program has been tampered with, a snapshot related to the program determined to have been tampered with.

### TECHNICAL FIELD

The present disclosure relates to an information processing apparatus, an information processing method, and a non-transitory computer readable medium storing a program.

### BACKGROUND ART

It is required that a security check function such as a tamper detection function be introduced into Internet of Things (IoT) devices. Further, in a case in which a program that is executed in an information processing apparatus mounted on an IoT device has been tampered with, it is required to promptly specify the program that has been tampered with, specify the cause of the tampering, and correct the vulnerability of the part of the program that has been tampered with. For example, Patent Literature 1 discloses a system that detects a tampering with a program.

Other descriptions regarding security check are disclosed also in Patent Literature 2.

### CITATION LIST

### Patent Literature

[Patent Literature 1] Japanese Unexamined Patent Application Publication No. 2014-229239
[Patent Literature 2] Japanese Unexamined Patent Application Publication No. 2010-250791

### SUMMARY OF INVENTION

### Technical Problem

According to the related art, however, it is impossible to specify when and which part of a program has been tampered with. Therefore, according to the related art, when a program has been tampered with, information on the whole program needs to be collected and a long-term execution log of the program needs to be stored, which causes a problem that an amount of information collected regarding the tampering is increased.

The present disclosure has been made in order to solve the aforementioned problem. That is, an object of the present disclosure is to provide an information processing apparatus, an information processing method, and a non-transitory computer readable medium storing a program capable of reducing an amount of information in a snapshot regarding a tampered program.

### Solution to Problem

An information processing apparatus according to the present disclosure includes: a memory that stores a program; whitelist storage means for storing a whitelist in which first verification data corresponding to each part of the program is listed; arithmetic processing means for executing the program; verification means for verifying whether there is a tampering with each part of the program by comparing the first verification data listed in the whitelist with second verification data that is newly calculated when each part of the program is executed; and information acquisition means for acquiring, when it is determined by the verification means that some part of the program has been tampered with, a snapshot related to the part of the program determined to have been tampered with.

Further, an information processing method according to the present disclosure includes: a verification step of verifying whether there is a tampering with each part of a program by comparing first verification data that is listed in a whitelist and corresponds to each part of the program with second verification data newly calculated when each part of the program is executed; and an information acquisition step of acquiring, when it is determined in the verification step that some part of the program has been tampered with, a snapshot related to the program determined to have been tampered with.

Further, a non-transitory computer readable medium according to the present disclosure stores a program for causing a computer to execute: verification processing of verifying whether there is a tampering with each part of the program by comparing first verification data that is listed in a whitelist and corresponds to each part of the program with second verification data newly calculated when each part of the program is executed; and information acquisition processing of acquiring, when it is determined in the verification step that some part of the program has been tampered with, a snapshot related to the program determined to have been tampered with.

### Advantageous Effects of Invention

According to the present disclosure, it is possible to provide an information processing apparatus, an information processing method, and a non-transitory computer readable medium storing a program capable of reducing an amount of information in a snapshot regarding a tampered program.

### BRIEF DESCRIPTION OF DRAWINGS

FIG. 1 is a block diagram showing a configuration example of an information processing apparatus according to a first example embodiment;

FIG. 2 is a diagram showing one example of a whitelist;

FIG. 3 is a flowchart showing an operation of the information processing apparatus shown in FIG. 1;

FIG. 4 is a diagram showing one example of an information processing system including the information processing apparatus shown in FIG. 1;

FIG. 5 is a diagram showing one example of a control flow graph; and

FIG. 6 is a diagram for describing a tamper detection method of a control flow graph by the information processing apparatus shown in FIG. 1.

### DESCRIPTION OF EMBODIMENTS

Example embodiments of the present invention will be described below with reference to the accompanying drawings. Note that the drawings are in simplified form and the technical scope of the example embodiments should not be interpreted to be limited to the drawings. The same elements are denoted by the same reference numerals and a duplicate description is omitted.

In the following example embodiments, when necessary, the present invention is explained by using separate sections or separate example embodiments. However, those example embodiments are not unrelated with each other, unless otherwise specified. That is, they are related in such a manner that one example embodiment is a modified example, an application example, a detailed example, or a supplementary example of a part or the whole of another example embodiment. Further, in the following example embodiments, when the number of elements or the like (including numbers, values, quantities, ranges, and the like) is mentioned, the number is not limited to that specific number except for cases where the number is explicitly specified or the number is obviously limited to a specific number based on its principle. That is, a larger number or a smaller number than the specific number may also be used.

Further, in the following example embodiments, the components (including operation steps and the like) are not necessarily indispensable except for cases where the component is explicitly specified or the component is obviously indispensable based on its principle. Similarly, in the following example embodiments, when a shape, a position relation, or the like of a component(s) or the like is mentioned, shapes or the like that are substantially similar to or resemble that shape are also included in that shape except for cases where it is explicitly specified or they are eliminated based on its principle. This is also true for the above-described number or the like (including numbers, values, quantities, ranges, and the like).

### First Example Embodiment

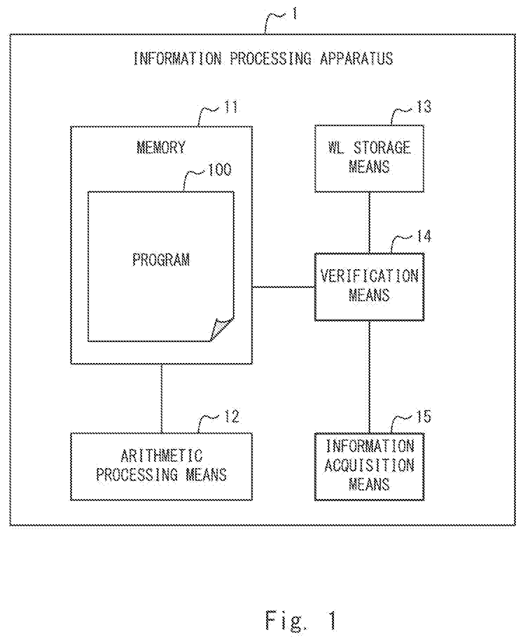

FIG. 1 is a block diagram showing a configuration example of an information processing apparatus 1 according to a first example embodiment.

As shown in FIG. 1, the information processing apparatus 1, which is mounted on, for example, an IoT device, includes a memory 11, arithmetic processing means 12, whitelist storage means (WL storage means) 13, verification means 14, and information acquisition means 15. The memory 11 stores a program 100.

The arithmetic processing means 12 executes the program 100 stored in the memory 11. The whitelist storage means 13 stores a whitelist 101 (not shown) of the program 100.

Verification data (expectation value) used to check whether there is a tampering with the program 100 is listed in the whitelist 101. The verification data is, for example, combinations of address values specifying storage areas of the memory 11 that store the respective parts of the program 100, and its hash values.

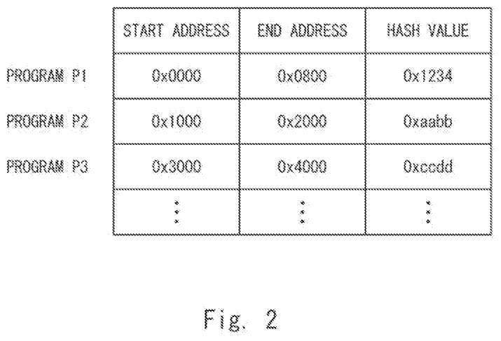

FIG. 2 is a diagram showing one example of the whitelist 101. In the example shown in FIG. 2, combinations of address values of areas where programs P1-P3, which are parts of the program 100, are stored, and its hash values are listed.

Specifically, a start address value of the program P1 is “0x0000”, an end address value thereof is “0x0800”, and a hash value of the program P1 is “0x1234”. Further, a start address value of the program P2 following the program P1 is “0x1000”, an end address value thereof is “0x2000”, and a hash value of the program P2 is “0xaabb”. Further, a start address value of the program P3 following the programs P1 and P2 is “0x3000”, an end address value thereof is “0x4000”, and a hash value of the program P3 is “0xccdd”.

The verification means 14 verifies whether there is a tampering with the program 100 before the program 100 stored in the memory 11 is executed by the arithmetic processing means 12. First, the verification means 14 newly calculates hash values of the respective parts of the program 100 stored in the memory 11. After that, the verification means 14 verifies whether there is a tampering with the program 100 by comparing the hash values of the respective parts of the program 100 that have been calculated with hash values (expectation values) of the program 100 listed in the whitelist 101.

When, for example, the hash value that corresponds to the program P1, which is a part of the program 100 stored in the memory 11, is different from the expected hash value “0x1234”, the verification means 14 determines that the program P1 is tampered with. In this example embodiment, the verification area can be limited and time required for the verification processing can be reduced since hash values are allocated to the respective parts of the program 100. When an information processing apparatus is mounted on an IoT device, it is especially efficient that the verification area be limited and the time required for the verification processing be reduced since the speed of the CPU, the size of the memory and the like are limited.

The information acquisition means 15 acquires, when it is determined by the verification means 14 that some part of the program 100 has been tampered with, a snapshot related to the part of the program determined to be tampered with. In other words, the information acquisition means 15 acquires the snapshot of the storage area of the memory that stores the part of the program determined to be tampered with.

The information acquisition means 15 acquires a snapshot of only a part of the program 100 that has been tampered with instead of acquiring a snapshot of the entire program 100. Further, the information acquisition means 15 acquires a snapshot of the tampered program at a timing when it is determined by the verification means 14 that some part of the program 100 is tampered with. Therefore, the information acquisition means 15 is able to reduce an amount of information in the snapshot (including information on the part of the program that has been tampered with, and a log that describes the execution state of the part of the program that has been tampered with).

The snapshot acquired by the information acquisition means 15 is transmitted, for example, to a security monitoring server (not shown) that is externally provided.

As described above, the information processing apparatus 1 according to this example embodiment acquires, only when it is determined that some part of the program has been tampered with, a snapshot of only the part of the program determined to have been tampered with. Accordingly, the information processing apparatus 1 according to this example embodiment is able to reduce an amount of information in the snapshot regarding the tampered program.

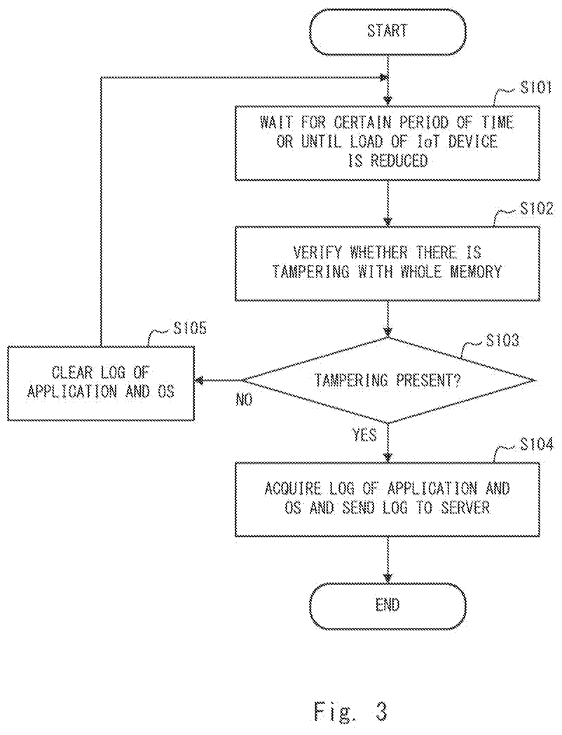

When none of the parts of the program 100 has been tampered with, a log of an application and an Operating System (OS), which is one of the targets to be acquired as a snapshot, may be cleared (deleted). This point will be briefly described with reference to FIG. 3.

FIG. 3 is a flowchart showing one example of an operation of the information processing apparatus 1.

As shown in FIG. 3, the information processing apparatus 1 first waits for a certain period of time or until the load of an IoT device on which the information processing apparatus 1 is mounted is reduced (Step S101). After that, it is verified whether there is a tampering with the whole program 100 stored in the memory 11 (Step S102). When it is determined that some part of the program 100 has been tampered with (YES in Step S103), the log of the application and the OS is acquired and this log is sent to, for example, a security monitoring server (Step S104). On the other hand, when it is determined that none of the parts of the program 100 is tampered with (NO in Step S103), the log of the application and the OS may be cleared (deleted) (Step S105). Accordingly, the size of the file of the log stored in the information processing apparatus 1 is reduced.

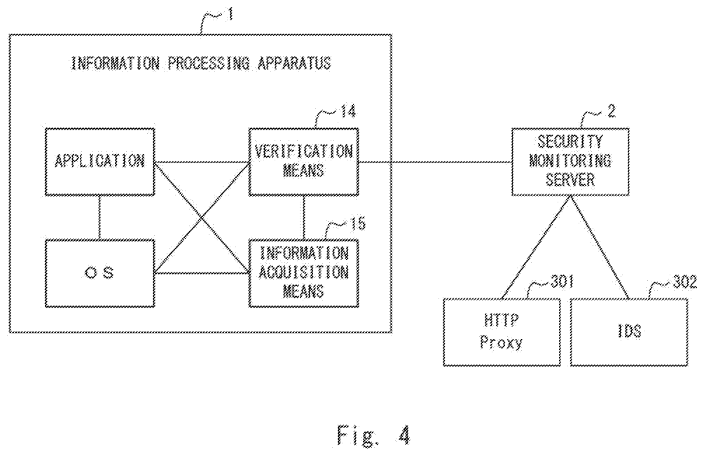

Further, what is sent to the security monitoring server is not limited to the snapshot acquired by the information acquisition means 15 provided in the information processing apparatus 1. What is sent other than the snapshot will be briefly described with reference to FIG. 4.

FIG. 4 is a diagram showing a configuration example of an information processing system including the information processing apparatus 1.

As shown in FIG. 4, besides a snapshot acquired by the information acquisition means 15 provided in the information processing apparatus 1, information regarding a tampering obtained from an external device such as an HTTP Proxy 301 or an IDS 302 may be transmitted to the security monitoring server 2. Note that the HTTP Proxy is an abbreviation for a Hyper Text Transfer Protocol Proxy. Further, the IDS is an abbreviation for an Intrusion Detection System. Accordingly, it becomes easy to specify the cause of the tampering with the program 100 of the information processing apparatus 1. Further, an amount of information regarding a tampering that should be acquired by the information acquisition means 15 can be reduced.

### Other Example Embodiments

While the case in which the combinations of the address values specifying the storage areas of the memory 11 that store the respective parts of the program 100, and its hash values are listed in the whitelist 101 has been described as an example in the first example embodiment, this is merely an example.

For example, in place of the hash values, index values (e.g., values of error correcting codes) that can be calculated from the entity of the respective parts of the program 100 and that can be used to check whether there is a tampering may be used.

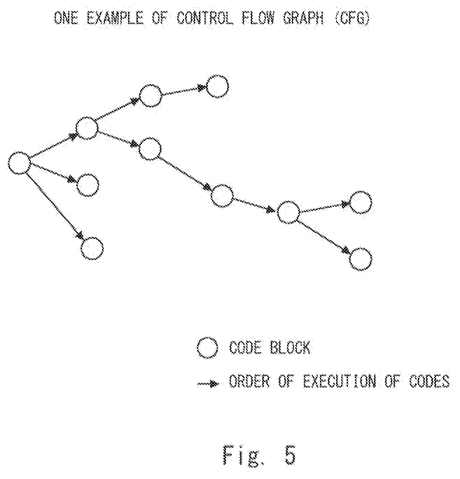

Alternatively, a control flow graph (CFG) that expresses a possible order of execution of a plurality of codes when the program 100 is executed may be listed in the whitelist 101 (see FIG. 5).

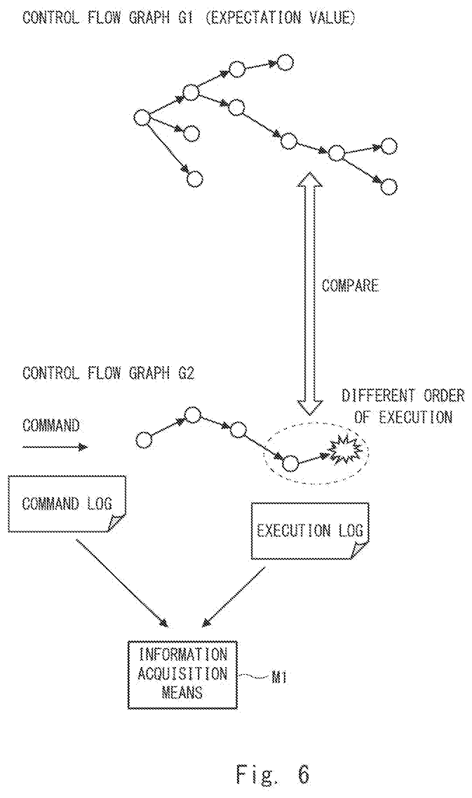

In this case, the verification means 14 compares a control flow graph G2 newly calculated during a period in which the program 100 is being executed by the arithmetic processing means 12 (or after the program 100 is executed by the arithmetic processing means 12) with a control flow graph G1 stored in the whitelist 101. Accordingly, it is verified whether or not there is a tampering with the program 100 (see FIG. 6). The tampering with the program at this time includes, besides a tampering with the program itself, a tampering with an order of execution of programs. Specifically, when a flow that is not recorded in the control flow graph G1 is recorded in the control flow graph G2, this state is detected as a tampering with an order of execution of programs. In other words, when the control flow graph G2 is not a partial graph of the control flow graph G1, this state is detected as a tampering with the order of execution of programs.

The information acquisition means 15 specifies, when it is determined by the verification means 14 that the program 100 has been tampered with, a difference between the control flows G1 and G2. Specifically, a control flow that is not recorded in the control flow graph G1 but is recorded only in the control flow graph G2 is specified as a control flow that violates the execution order. Then, a log that describes the execution state of the program when a control flow that violates the execution order has occurred (when the execution order is violated) or when the violation of the execution order has been detected is acquired as a snapshot. The execution state here means a state of the control flow graph G2, a memory (a stack or a heap) of the program, or the register of the CPU. Regarding the control flow graph G2, only the part of the control flow graph G2 that is not included in the control flow graph G1 (a control flow that has violated the execution order) may be acquired or the entire control flow graph G2 may instead be acquired. In addition, when an address of a return destination (return address) of a function is recorded on the stack, the memory indicated by this address may be added to the snapshot. Further, the information acquisition means 15 also acquires an external input that has caused a tampering such as a log of a command or data externally received as a snapshot.

Both the combinations of the address values specifying the storage areas of the memory 11 that store the respective parts of the program 100, and its hash values, and the control flow graphs may be listed in the whitelist 101. It is therefore possible to verify whether there is a tampering with a program more accurately.

The snapshot acquired by the information acquisition means 15 is transmitted, for example, to a security monitoring server (not shown) externally provided. Further, the snapshot may be stored in an internal storage. In this case, the snapshot may be stored in a non-rewritable storage (Write Once Read Many media) or a storage that can be read and written from only the information acquisition means 15 in order to prevent the snapshot from being tampered with. Further, the information acquisition means 15 may grant an electronic signature for preventing a tampering with the snapshot before externally transmitting the snapshot or before storing the snapshot in an internal storage.

While the example embodiments of the present disclosure have been described in detail with reference to the drawings, the specific configurations are not limited to the aforementioned ones and various changes in design may be possible without departing from the spirit of the present disclosure. For example, a function of implementing the operation of the whitelist generation apparatus may be formed of and operated by a plurality of apparatuses connected by a network.

While the present disclosure has been described as a hardware configuration in the aforementioned example embodiments, the present disclosure is not limited thereto. The present disclosure can achieve a part of the processing or the whole processing of the whitelist generation apparatus by causing a Central Processing Unit (CPU) to execute a computer program.

While the whitelist storage means 13, the verification means 14, and the information acquisition means 15 are configured to be executed in an area the same as that of the program 100 of hardware or a CPU in the above example embodiment, they may be configured to be executed in an area separated from the program 100. According to this configuration, it is possible to prevent the whitelist storage means 13, the verification means 14, and the information acquisition means 15 from being attacked through an attacked program 100. Specifically, the whitelist storage means 13, the verification means 14, and the information acquisition means 15 may be configured to be operated by a CPU or a memory other than a CPU or a memory on which the program 100 runs or may be configured to be operated in a TEE provided by the CPU. Note that TEE is an abbreviation for Trusted Execution Environment. TEE may be, for example, Secure World provided by ARM TrustZone.

Further, the above-described program can be stored and provided to a computer using any type of non-transitory computer readable media. Non-transitory computer readable media include any type of tangible storage media. Examples of non-transitory computer readable media include magnetic storage media, optical magnetic storage media, CD-Read Only Memory (ROM), CD-R, CD-R/W, semiconductor memories. Magnetic storage media includes, for example, flexible disks, magnetic tapes, hard disk drives, etc. Optical magnetic storage media include, for example, magneto-optical disks. Semiconductor memories include, for example, mask ROM, Programmable ROM (PROM), Erasable PROM (EPROM), flash ROM, Random Access Memory (RAM), etc. The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

While the present invention has been described above with reference to the example embodiments, the present invention is not limited by the above example embodiments. Various changes that may be understood by those skilled in the art within the scope of the invention may be made to the configurations and the details of the present invention.

### REFERENCE SIGNS LIST

1 Information Processing Apparatus
2 Security Monitoring Server
11 Memory
12 Arithmetic Processing Means
13 Whitelist Storage Means
14 Verification Means
15 Information Acquisition Means
100 Program
101 Whitelist
301 HTTP Proxy
302 IDS
G1, G2 Control Flow Graph
P1-P3 Program

What is claimed is:

1. An information processing apparatus comprising:
at least one first memory storing instructions; and
at least one processor configured to execute the instructions stored in the first memory to:
store a program in a predetermined memory;
store a whitelist in which first verification data corresponding to each part of the program is listed;
execute the program;
verify whether there is a tampering with each part of the program by comparing the first verification data listed in the whitelist with second verification data that is newly calculated when each part of the program is executed; and
acquire, when it is determined in the verification that some part of the program has been tampered with, a snapshot related to the part of the program determined to have been tampered with.

2. The information processing apparatus according to claim 1, wherein
the first verification data is composed of address values of the predetermined memory that store the respective parts of the program and first eigenvalues that correspond to the respective parts of the program, and
the second verification data is data that corresponds to the first verification data newly calculated when each part of the program is executed.

3. The information processing apparatus according to claim 2, wherein in the acquisition, when it is determined in the verification that some part of the program has been tampered with, a snapshot of a storage area of the predetermined memory that stores the program determined to have been tampered with is acquired.

4. The information processing apparatus according to claim 1, wherein
the first verification data is a control flow graph expressing a possible order of execution of a plurality of codes when the program is executed, and
the second verification data is data that corresponds to the first verification data newly calculated when the program is executed.

5. The information processing apparatus according to claim 4, wherein
in the verification, it is determined that some part of the program has been tampered with when the control flow graph expressed by the first verification data is different from a control flow graph expressed by the second verification data, and
in the acquisition, when it is determined in the verification that some part of the program has been tampered with, at least one of a log that describes the execution state of the program in a part of the control flow graph expressed by the second verification data that is different from the control flow graph expressed by the first verification data, and a log of an external command that has caused the tampering is acquired as the snapshot.

6. The information processing apparatus according to claim 1, wherein, when it is determined in the verification that the program has not been tampered with, an execution log that describes the execution state of the program by the arithmetic processing means is deleted.

7. An information processing method comprising:
verifying whether there is a tampering with each part of a program by comparing first verification data that is listed in a whitelist and corresponds to each part of the program with second verification data newly calculated when each part of the program is executed; and
acquiring, when it is determined that some part of the program has been tampered with, a snapshot related to the program determined to have been tampered with.

8. A non-transitory computer readable medium storing a program causing a computer to execute:
verification processing of verifying whether there is a tampering with each part of the program by comparing first verification data that is listed in a whitelist and corresponds to each part of the program with second verification data newly calculated when each part of the program is executed; and
information acquisition processing of acquiring, when it is determined in the verification processing that some part of the program has been tampered with, a snapshot related to the program determined to have been tampered with.
